(19) United States
(12) Patent Application Publication
(10) Pub. No.: US 2006/0062365 A1
(43) Pub. Date: Mar. 23, 2006

(54) Method, system, and terminal equipment enabling personalized call notification

(75) Inventors: James Tien-Cheng Yeh, Beijing (CN); Wei BJ. Lu, Beijing (CN); Jun LJ. Liu, Beijing (CN); Chun Ying, Beijing (CN); Ben Bo Yang, Beijing (CN); Qing Bo Wang, Beijing (CN)

Correspondence Address: Lily Neff;IBM Corporation, MS P386, 2455 South Road, Poughkeepsie, NY, 12601, US

(73) Assignee: International Business Machines Corporation, Armonk, NY (US)

(21) Appl. No.: 11/231,844

(22) Filed: Sep. 21, 2005

(30) Foreign Application Priority Data
Sep. 22, 2004 (CN) 2004100800268

(51) Int. Cl. H04M 15/06; H04M 1/56

(52) U.S. Cl. 379/142.1; 379/156; 379/142.01

(57) ABSTRACT

A system and method for implementing personalized call notification, a method for setting personalized call notification, and an application server, service server and switch used in the system for implementing personalized call notification has been provided. The system for implementing personalized call notification comprises: a switch for calling a callee terminal equipment according to the call request coming from a caller terminal equipment; an application server for storing therein the profile containing the personalized information of said callee and selecting the type of call notification according to said profile and the information related to said call request that comes from said switch; and a service server for storing therein the tone information corresponding to respective call notification types and based on the selection of said application server, sending the tone information corresponding to said selected call notification type to said callee terminal equipment.

### CROSS-REFERENCE TO RELATED APPLICATION

This application claims the priority benefit under 35 USC 119 of China patent application 2004100800268 filed Sep. 22, 2004 and is incorporated herein by reference.

### TECHNICAL FIELD OF THE INVENTION

The present invention relates to the field of communication, in particular, to the technology of enabling personalized call notification in a telecommunication system.

### BACKGROUND OF THE INVENTION

In a current telecommunication system, in addition to the core voice service, operators and service providers also provide a great deal of personalized data services as value-added services. New kinds of personalized services are the focal point for operators and service providers to increase their revenue and attract more customers.

At the same time, various terminal equipments (TE) of telecommunication systems are playing a more and more important role in people's daily life, said terminal equipments comprising: powerful intelligent terminal equipments, such as mobile phone and VoIP terminal equipments etc., and simple but practical ordinary terminal equipments, such as ordinary telephone (POTS telephone) etc.

It is known at present that there is a technical solution that notifies a incoming call on a mobile phone with different tones according to different caller IDs, that is, the tone files for various kinds of tones are stored on the terminal equipment, and then for each possible call ID the corresponding tone file is set on the terminal equipment, thereby enabling prompting different tones for calls from different caller IDs.

However, this method of personalized call notification in the prior art has following problems: firstly, only a powerful intelligent terminal equipment can implement this technical solution, since the terminal equipment needs to store a great deal of tone files and make choice when a call arrives, and ordinary POTS telephone can not implement this technical solution; secondly, since it is managed in a distributed way, each terminal equipment has to be configured separately, and it is very inconvenient in the case of changing the terminal equipment or one user using multiple terminal equipments; in addition, since this kind of personalized call notification is implemented as a feature of the terminal equipment, it cannot be an operator's value-added service.

### SUMMARY OF THE INVENTION

In view of the above problems in the prior art, the present invention is proposed, the object of which is to provide a method and a system, as well as a terminal equipment, an application server and a service server, which implement personalized call notification in a centralized way.

According to one aspect of the invention, there is provided a system for implementing personalized call notification, comprising: a switch for calling a callee terminal equipment according to a call request coming from a caller terminal equipment; an application server for storing therein a profile containing the personalized information of said callee and selecting the type of call notification according to said profile and the information related to said call request that comes from said switch; and a service server for storing therein tone information corresponding to various call notification types and based on the selection of said application server, sending tone information corresponding to said selected call notification type to said callee terminal equipment.

According to another aspect of the invention, there is provided a system for implementing personalized call notification, comprising: a switch for calling a callee terminal equipment according to a call request coming from a caller terminal equipment; an application server for storing therein a profile containing the personalized information of said callee and selecting the type of call notification according to said profile and the information related to said call request that comes from said switch; and a service server for storing therein tone information corresponding to various call notification types and based on the selection of said application server, sending tone information corresponding to said selected call notification type to said switch; wherein said switch sends the corresponding ringing signal to said callee terminal equipment according to said tone information coming from said service server.

According to yet another aspect of the invention, there is provided a method for implementing personalized call notification, comprising: sending a call request to a callee from a caller; selecting a call notification type according to said call request and said callee's personalized information; sending tone information corresponding to the selected call notification type to the callee terminal equipment; and rendering said tone information on the callee terminal equipment as a call notification.

According to yet another aspect of the invention, there is provided a method for implementing personalized call notification, comprising: sending a call request to a callee from a caller; selecting a call notification type according to said call request and said callee's personalized information; sending the selected call notification type to the callee terminal equipment, wherein said terminal equipment has stored therein tone information corresponding to said call notification type; and rendering said tone information on the callee terminal equipment as a call notification.

According to yet another aspect of the invention, there is provided a method for implementing personalized call notification, comprising: sending a call request to a callee from a caller; selecting a call notification type according to said call request and said callee's personalized information; sending tone information corresponding to the selected call notification type to a switch connected with the callee terminal equipment; converting said tone information into the corresponding ringing signal at said switch and sending it to said callee terminal equipment; and ringing on the callee terminal equipment according to said ringing signal as a call notification.

According to yet another aspect of the invention, there is provided a telephone terminal equipment, characterized in that, comprising: a notification tone receiving unit for receiving tone information of personalized call notification; and notification tone rendering unit for rendering the received tone information of personalized call notification to notify the user that a call arrives.

According to yet another aspect of the invention, there is provided an application server, comprising: a user profile database for storing profiles containing personalized information for personalized call notification; call information receiving means for receiving information related to a call request; and notification type selecting means for selecting a call notification type for a call request according to the received information related to the call request and the personalized information stored in said user profile database.

According to yet another aspect of the invention, there is provided a service server, comprising: a notification tone database for storing a plurality of call notification types and their corresponding tone data; notification tone retrieving means for retrieving tone data corresponding to a specified notification type from said notification tone database; and notification tone outputting means for outputting tone data retrieved by said notification tone retrieving means.

According to yet another aspect of the invention, there is provided a switch, characterized in that, comprising: a personalized notification triggering database for storing the users' information for which personalized call notification has been set; personalized notification determining means for determining whether the callee of a received call request has set personalized call notification according to the information in said personalized notification triggering database; and call information outputting means for outputting information related to the call request for which the callee has set personalized call notification according to the determinination result of said personalized notification determining means.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a structure diagram of the system for implementing personalized call notification according to one embodiment of the present invention;

FIG. 2 is a structure diagram of the system for implementing personalized call notification according to another embodiment of the present invention;

FIG. 3 depicts a block diagram of the structure of an application server according to one embodiment of the present invention;

FIG. 4 depicts a block diagram of the structure of a service server according to one embodiment of the present invention;

FIG. 5 depicts a block diagram of the structure of a switch according to one embodiment of the present invention;

FIG. 6 depicts a block diagram of the structure of a callee terminal equipment according to one embodiment of the present invention;

FIG. 7 is a flowchart of the method for setting personalized call notification according to one embodiment of the present invention;

FIG. 8 is a flowchart of the method for implementing personalized call notification according to one embodiment of the present invention;

FIG. 9 is a flowchart of the method for implementing personalized call notification according to another embodiment of the present invention; and

FIG. 10 is a flowchart of the method for implementing personalized call notification according to yet another embodiment of the present invention.

### DETAILED DESCRIPTION OF THE INVENTION

The capabilities of the present invention can be implemented in software, firmware, hardware or some combination thereof.

Next, various preferred embodiments of the present invention will be described in detail in conjunction with accompany drawings.

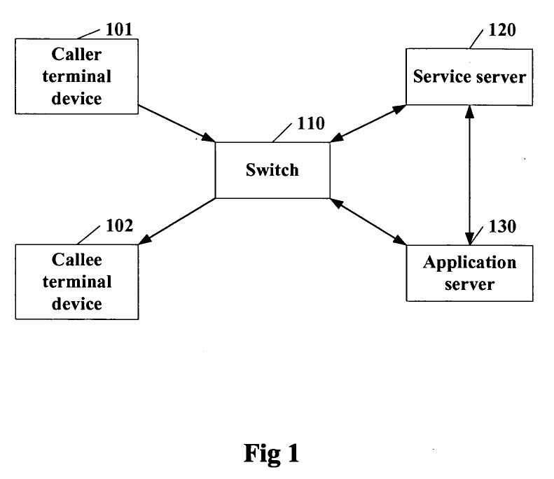

FIG. 1 is a structure diagram of the system for implementing personalized call notification according to one embodiment of the present invention. In FIG. 1, a caller terminal equipment 101, a switch 110 and a callee terminal equipment 102 form a conventional telecommunication system, such as a PSTN system or a mobile communication system. In which, the caller terminal equipment 101 and the callee terminal equipment 102 (of course there can be more terminal equipments) are connected to the switch 110 respectively. The switch 110 calls the callee terminal equipment 102 according to a call request coming from the caller terminal equipment 101. Here, the switch 110 may be a separate equipment or a switch system formed by a plurality of switches. This is well known to those skilled in the art.

The system for implementing personalized call notification of the present embodiment, as shown in FIG. 1, in addition to the above components, also includes a service server 120 and an application server 130. They are used to manage personalized setting information and tone data of personalized notification and handle call requests to enable personalized call notification in a centralized way.

In particular, the application server 130 stores profiles set by the system's users that contain personalized information, and selects the type of call notification when a call request occurs according to a profile and the information coming from switch 110 that is related to the call request.

Following is one example of a personalized information profile set by a user:
callee_id=82782244
[option 1]
   condition: caller_id=62986677 (and) location=office (and) time>12:00:00
   selection: tone1
[option 2]
   condition: caller_id=65391188 (and) location=home (and) time>20:00:00
   selection: tone2
[option 3]
   condition: *
selection: tone3

In the example it can be seen that each user can set multiple selection entries, such as option1-option3, each selection entry including condition information and the corresponding call notification type ID (such as tone1-tone3 etc). The condition information may include selection conditions such as the callee ID, caller ID, callee's location, caller's location and call time, etc. Application server 130 determines if the occurring call request meets the criteria specified in the condition information, and if yes, then the call notification type (ID) corresponding to the condition will be selected. Of course, the condition information may also include other contents; any information that is available when handling a call request is applicable.

Service server 120 is used to store multiple call notification types that can be selected by a user and the tone data (tone information) corresponding to each notification type, and retrieve the corresponding tone data according to the call notification type (ID) selected by the application server 130. In different embodiments, the tone data may be sound files, such as WAV, MP3, RAM etc. files, or scripts (will be described later) that define ringing frequencies and intervals, or may be data in other formats, even data that contains both audio and video data etc.

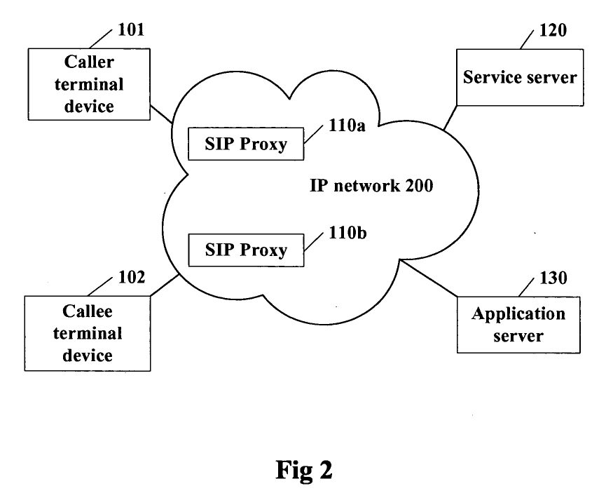

FIG. 2 is a structure diagram of the system for implementing personalized call notification according to another embodiment of the present invention. The system for implementing personalized call notification as shown in FIG. 2 differs from that in FIG. 1 in that what is shown in FIG. 2 is a telecommunication system based on an IP network 200, that is, a caller terminal equipment 101 and a callee terminal equipment 102 are a VoIP terminal respectively; SIP Proxy 110a, 110b, as switch nodes for handling call requests, have replaced the switch 110 in FIG. 1 (referred to as switch 110 in the following description of the application); further, the service server 120 and application server 130 are connected to the IP network 200 respectively.

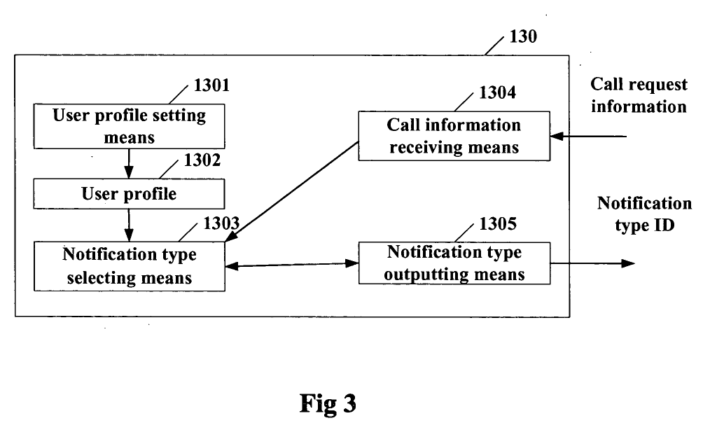

The detailed structure of the application server 130, service server 120, switch 110 and callee terminal equipment 102 will be described in the following in conjunction with FIG. 3 to FIG. 6.

FIG. 3 depicts a block diagram of the structure of an application server according to one embodiment of the present invention. As shown in FIG. 3, the application server 130 comprises: a user profile database 1302 for storing profiles containing the personalized information set by users; call information receiving means 1304 for receiving information related to a call request from the switch 110 which handles call requests, said information comprising, for example, the callee ID, caller ID, callee's location, caller's location and call time, etc.; notification type selecting means 1303 for retrieving the profile set by the callee user according to the callee ID in the received information of a call request and for comparing the conditions defined in said profile with the call request information to select a call notification type; and notification type outputting means 1305 for outputting the notification type (ID) selected by the notification type selecting means 1303.

Further, the application server 130 may also comprise user profile setting means 1301 for allowing users to set, modify their own personalized information.

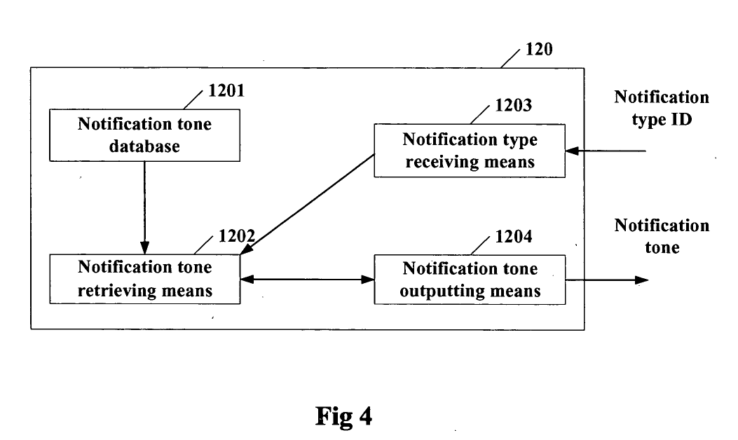

FIG. 4 depicts a block diagram of the structure of a service server according to one embodiment of the present invention. As shown in FIG. 4, the service server 120 comprises: a notification tone database 1201 for storing various call notification types and their corresponding tone data; notification type receiving means 1203 for receiving from the application server 130 a call notification type (ID) selected by the application server 130; notification tone retrieving means 1202 for retrieving tone data corresponding to the selected notification type (ID) from the notification tone database 1201; and notification tone outputting means 1204 for outputting tone data retrieved by the notification tone retrieving means 1202.

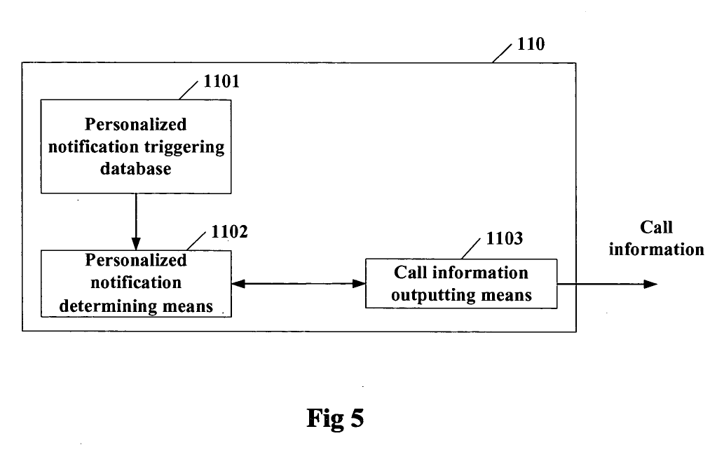

FIG. 5 depicts a block diagram of the structure of a switch according to one embodiment of the present invention. As shown in FIG. 5, according to one embodiment of the present invention, on the basis of a conventional switch, the switch 110 may further comprises: a personalized notification triggering database 1101 for storing those users' information for which personalized call notification has been set, specifically, storing all the callee IDs in the user profile database 1302 of the application server 130; personalized notification determining means 1102 for determining whether the callee (ID) of the call request currently being handled has set personalized call notification; and call information outputting means 1103 for outputting those call request information in which the callee has set personalized call notification to the application server 130 according to the determination result of the personalized notification determining means 1102.

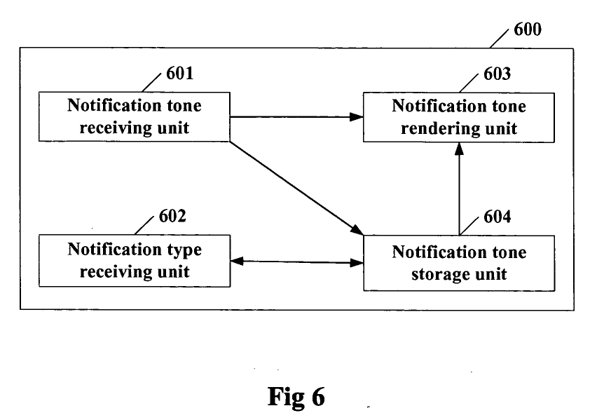

FIG. 6 depicts a block diagram of the structure of a callee terminal equipment according to one embodiment of the present invention. As shown in FIG. 6, on the basis of a conventional terminal equipment (such as, a mobile phone terminal, VoIP terminal etc.), the callee terminal equipment 600 of the present embodiment further comprises: notification tone receiving unit 601 for receiving the tone information of a personalized call notification when an incoming call occurs, specifically, if notification tone information is transmitted via signaling, this can be implemented by utilizing the receiving means on a conventional terminal equipment in conjunction with signaling decoding means; and notification tone rendering unit 603 for rendering the tone information of a received personalized call notification to notify the user there is an incoming call, specifically, this can be implemented by utilizing audio and/or video rendering means according to the format of tone information.

Further, the callee terminal equipment 600 may also comprises: a notification type receiving unit 602 for receiving the type information of a personalized call notification, and similar to the notification tone receiving unit 601, when notification type information is transmitted via signaling, this can be implemented by utilizing the receiving means on a conventional terminal equipment in conjunction with signaling decoding means; and notification tone storage unit 604 for storing the tone information of a received personalized call notification, specifically, it may be memory or storage in any form. Thus, when said notification tone storage unit 604 has stored therein the tone information to be rendered, there is no need for the callee terminal equipment 600 to be transferred the tone information again, thereby saving bandwidth and processing time.

In addition, according to another embodiment of the present invention, on the basis of a conventional terminal equipment, the callee terminal equipment 600 may further comprises: a notification tone receiving unit 601 for receiving tone information of a personalized call notification; a notification tone storage unit 604 for storing the received tone information of a personalized call notification; a notification type receiving unit 602 for receiving the type information of a personalized call notification when there is an incoming call; and a notification tone rendering unit 603 for rendering the tone information corresponding to the call notification type according to the type information of the call notification received by the notification type receiving unit to notify the user there is an incoming call.

Thus, through downloading and storing all the tone information corresponding to the notification types to be used in the notification tone storage unit 604 in advance (for example, when setting personalized call notification) by the notification tone receiving unit 601, each time there is an incoming call, all has to be done is to receive the notification type information from the application server 130, and then the corresponding tone information can be retrieved from the notification tone storage unit 604 and personalized call notification can be enabled. In this way, the speed of handling incoming calls can be further increased.

The above described various components in the system for implementing personalized call notification of the present embodiment can be implemented in the form of software or hardware and can be set to be physically separated but operationally interconnected with each other, or some of the components may be implemented in combination. For example, the application server 130 and service server 120 of the present invention may be two interconnected computers, or may be implemented by one computer system, and the service server 120 can be implemented as an intelligent peripheral of the application server 130. In the case in which the application server 130 and service server 120 are implemented in combination, the components for communication between the application server 130 and service server 120 can be omitted. In addition, in the following description, while the case in which the application server 130 and service server 120 are implemented separately is illustrated as an example, it should be noted that it is similar for the case in which the application server 130 and service server 120 are implemented in combination.

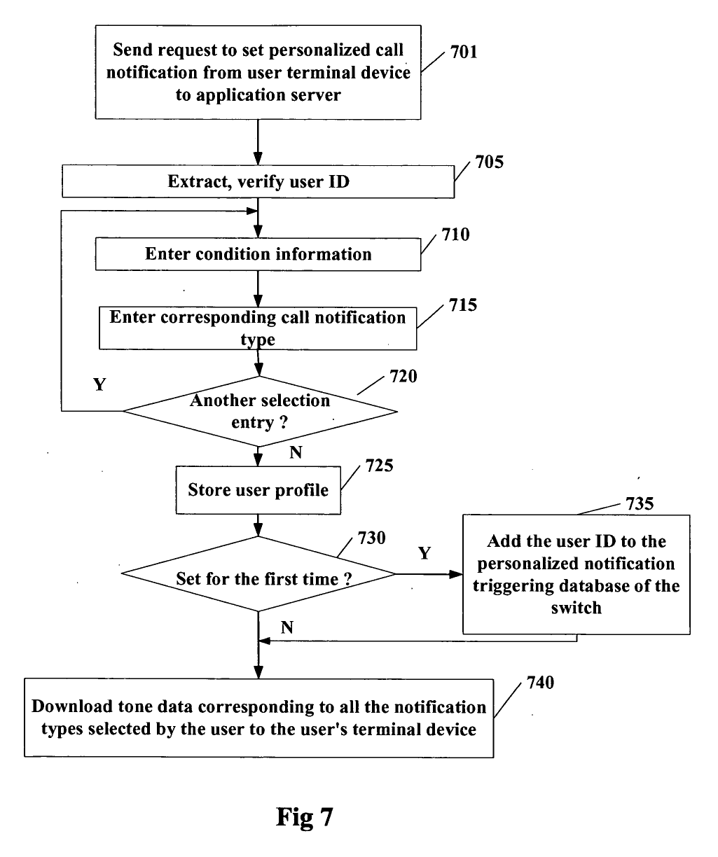

The operational processes of the above system for implementing personalized call notification will be described in the following in conjunction with FIG. 7 to FIG. 10.

FIG. 7 is a flowchart of the method for setting personalized call notification according to one embodiment of the present invention. It should be noted that as a telecommunication value-added service, there are many ways to set personalized call notification, for example, it can be set by a system administrator according to a user's requirements, which will not influence the implementation of the above described system for implementing personalized call notification and the following described method for implementing personalized call notification of the present invention. Here, the embodiment shown in FIG. 7 is a method in which a user use a terminal equipment to set personalized call notification through the interaction between the terminal equipment and application server 130.

As shown in FIG. 7, first at Step 701, a request to set personalized call notification is sent from a user's terminal equipment (for example, 102 in FIG. 1) to the application server 130. Specifically, this can be performed by way of, for example, dialing a specific phone number or sending a short message.

Next, at Step 705, the application server 130 extracts and verifies the user ID. Specifically, the application server 130 extracts the user ID from the request coming from the user's terminal equipment and verifies whether the user ID is valid. If the user ID is invalid, the application server 130 may deny that request and ends the handling process (not shown in the figure).

Next, at Step 710, the user enters condition information through the terminal equipment; the content of condition information has been described above and will be omitted here for brevity. Specifically, the user may be prompted to enter condition information by way of voice or short message, then the user can send desired condition information to the application server 130 by way of keys or short message.

Next, at Step 715, the user enters a call notification type corresponding to the condition. Specifically, the user may directly entered the call notification type ID by way of keys or short message, or the user may be allowed to select from the playing tone information (demonstration samples) of various notification types that is played.

Next, at Step 720, it is determined if the user needs to continue to enter a next selection entry. If Yes, then the process returns to Step 710, and the user continues to enter the next condition; otherwise, the process proceeds to Step 725.

At Step 725, all the selection entries entered by the user are stored as the profile for that user.

Next, at Step 730, it is determined if it is the first time for the user to set personalized call notification. If Yes, then Step 735 is performed, and the user ID is added into the personalized notification triggering database 1101 of the switch 110, thereby keeping data consistency between the switch 110 and application server 130; otherwise, Step 740 is performed directly.

At Step 740, the tone data corresponding to all the notification types selected by the user is downloaded to the user's terminal equipment.

It should be noted that the method of setting personalized call notification of the present embodiment is also equally applicable to the case in which a user performs the setting via a computer network. In addition, when the switch 110 does not have a personalized notification triggering database 1101, Step 730 and 735 can be omitted; when tone information is not stored in the terminal equipment, Step 740 can also be omitted.

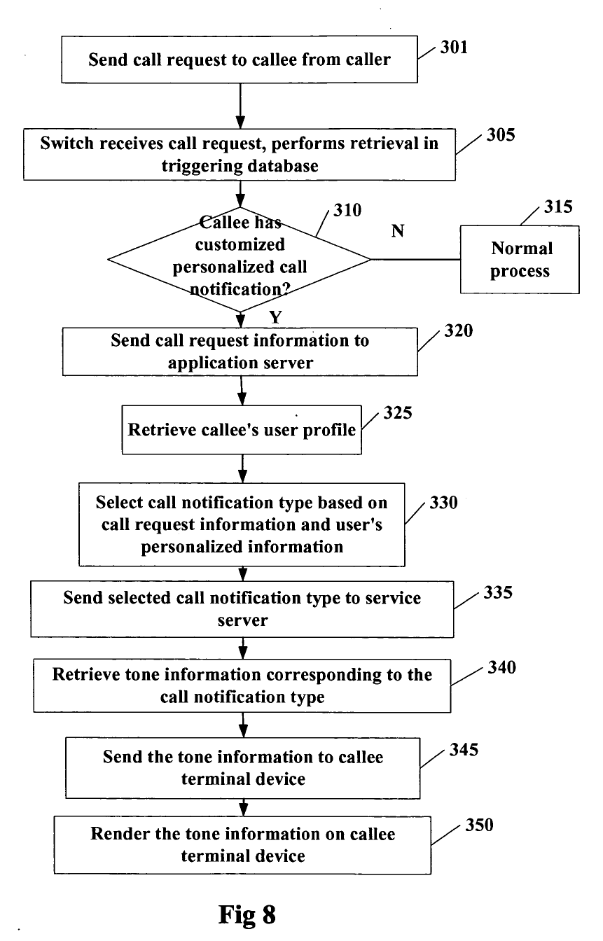

FIG. 8 is a flowchart of the method for implementing personalized call notification according to one embodiment of the present invention. As shown in FIG. 8, first at Step 301, a call request is sent from a caller to a callee, specifically, this step is performed by a caller user dialing a callee ID using the caller terminal equipment 101.

Next, at Step 305, the switch receives that a call request and performs a retrieval in a personalized notification triggering database; at Step 310, it is determined whether the callee of the call request has subscribed personalized call notification, and if Yes, then the process proceeds to Step 320, otherwise, to Step 315, and handles it as a normal call request.

As shown above, when the switch 110 (or switch node 110a, 110b) has a personalized notification triggering database 1101, whether each call request needs to be specially handled with personalized call notification is determined according to the callee IDs recorded in the personalized notification triggering database 1101, and only information of those call requests which need to be handled in a personalized way will be sent to the application server 130, thereby the handling time can be greatly saved and the handling speed can be improved.

Of course, the switch 110 may also have no personalized notification triggering database 1101, and at this time, the switch 110 needs to send the related information to the application server 130 for each call request and the determination will be made by the application server 130. In this case, Step 305-315 may be omitted.

Next, at Step 320, the switch 110 sends the call request information to the application server 130. In the present embodiment, the call request information may include the callee ID, caller Id, callee's location, caller's location and call time. In addition, other information that is available to the switch 110 and can be used by a user to set personalized conditions may also be sent to the application server 130 as call request information, and the present invention has no particular limitation to this.

Next, at Step 325, the application server 130 retrieves the user profile of the callee of the call request from the user profile database 1302.

Next, at Step 330, the application server 130 selects the type of call notification according to the call request information and the user's personalized information. Specifically, as indicated above, the call request is determined as to whether it meets a condition (such as the callee ID, caller Id, callee's location, caller's location and call time) set in the user profile, and if Yes, then the call notification type (ID) corresponding to the condition is selected.

Next, at Step 335, the application server 130 sends the selected call notification type (ID) to the service server 120. Here, if the application server 130 and service server 120 are implemented by one computing system, this step can be omitted.

Next, at Step 340, the service server 120 retrieves the tone information corresponding to the notification type (ID) from the notification tone database 1201.

Next, at Step 345, the service server 120 sends the information to the callee terminal equipment. In the present embodiment, preferably, the tone information is sent to the callee terminal equipment in the form of signaling.

Next, at Step 350, the tone information is rendered on the callee terminal equipment 102 as a call notification. Specifically, when the tone information is sound data, the callee terminal equipment 102 will play the sound data. When the tone information also includes image data, the image can also be displayed on the callee terminal equipment 102.

From the above description it can be seen that, by utilizing the present embodiment, personalized call notification may be customized for different incoming calls according to users's settings, and since it is managed and controlled in a centralized way, it may be a value-added service for an operator.

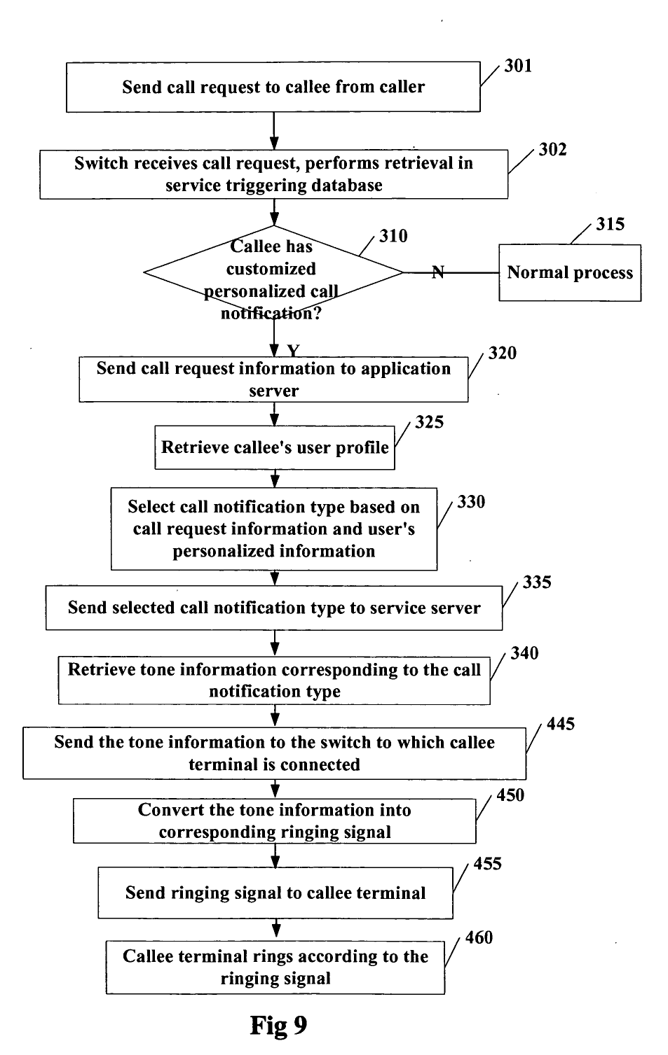

FIG. 9 is a flowchart of the method for implementing personalized call notification according to another embodiment of the present invention. In which, a same part as in the embodiment shown in FIG. 8 is labeled with a same reference number and its description is omitted where appropriate.

The present embodiment differs from the embodiment shown in FIG. 8 in that the embodiment of FIG. 8 is applicable to the case where the callee terminal equipment 102 is an intelligent terminal equipment (such as a mobile phone terminal, VoIP terminal etc), since the callee terminal equipment 102 needs to be able to process and render notification tone information. However, where the callee terminal equipment 102 is an ordinary telephone terminal (such as a POTS telephone), the embodiment of FIG. 8 cannot be implemented, since a POTS telephone cannot receive and render tone information. While the present embodiment is aimed at this case.

As shown in FIG. 9, first, Step 301-340 is the same as those in the embodiment of FIG. 8 and their description is omitted here.

Next, after the tone information has been retrieved by the service server 120, at Step 445, the retrieved tone information is sent to the switch 110 to which the callee terminal is connected. In the present embodiment, since the callee terminal equipment is a POTS telephone, the notification tone information is a script that defines a ringing frequency and interval.

Next, in switch 110, the tone information is converted into a corresponding ringing signal. Specifically, the switch 110 generates the corresponding ringing signal according to the ring frequency and interval defined in the tone information. In the present embodiment, preferably, the tone information is sent to the switch 110 in the form of signaling. As is known to those skilled in the art, the generation of the corresponding ringing signal according to signaling may be implemented in a conventional switch.

Next, at Step 455, the ringing signal is sent from the switch 110 to the callee terminal equipment 102. Then at Step 460, the callee terminal equipment 102 rings according to the ringing signal as a call notification.

According to the present embodiment, not only personalized call notification may be customized for different incoming calls according to users' settings, further, for those non-intelligent terminal equipment, personalized call notification may also be customized, thereby the scope of an operator's value-added service is greatly broadened.

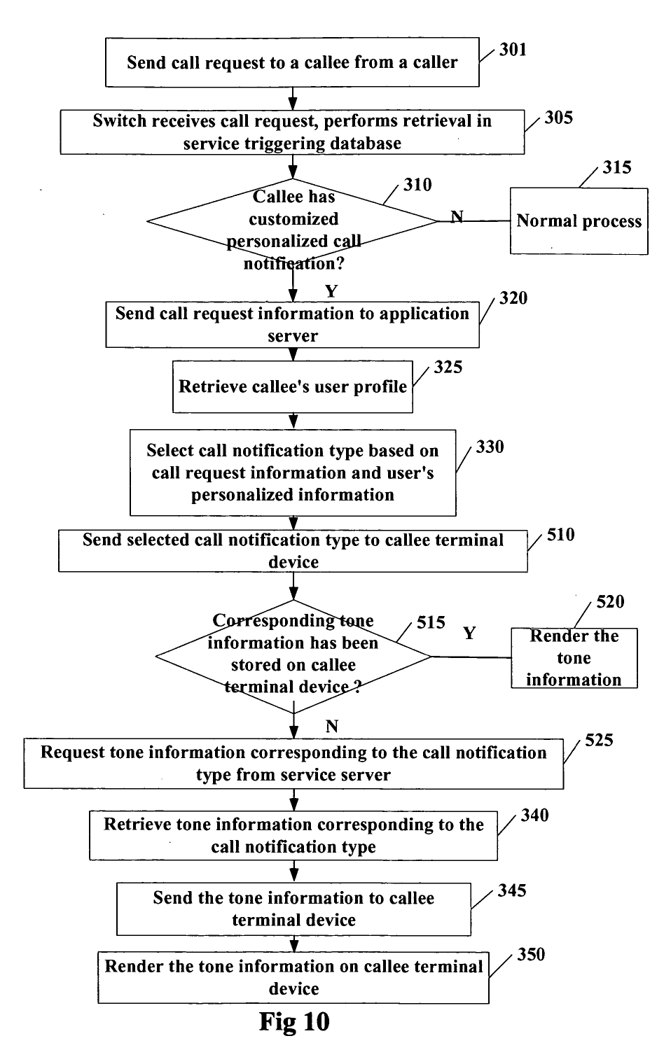

FIG. 10 is a flowchart of the method for implementing personalized call notification according to yet another embodiment of the present invention. In which, a same part as in the embodiment shown in FIG. 8 is labeled with a same reference number and the its description is omitted where appropriate.

The present embodiment differs from the embodiment shown in FIG. 8 in that the callee terminal equipment 102 has a notification tone storage unit 604, which can store the tone data for personalized call notification.

As shown in FIG. 10, first, Step 301-330 is the same as those in FIG. 8 and their description is omitted here.

Next, when the call notification type (ID) has been selected, at Step 510, the selected call notification type is sent to the callee terminal equipment 102. In the present embodiment, preferably, the call notification type ID is sent to the callee terminal equipment via signaling.

Next, it is determined whether the callee terminal equipment 102 has stored therein the tone information corresponding to that notification type (ID). If Yes, then the process proceeds to Step 520, and the tone information is rendered directly as a call notification, otherwise, the process proceeds to Step 525.

At Step 525, the callee terminal equipment 102 requests the tone information corresponding to that call notification type from the service server 120. Then, as the same as in the embodiment in FIG. 8, the process performs Step 340-350, and the tone information is downloaded and rendered on the callee terminal equipment 102.

By employing the present embodiment, when the callee terminal equipment has stored therein the corresponding notification tone information, there is no need to transfer it again, thereby bandwidth and handle time may be saved.

Further, according to one preferred embodiment of the present invention, as mentioned above, it is also possible that all tone information used by a user may be downloaded to a user's terminal equipment when or after the user sets personalized information (that is, a user profile), thus, when a incoming call arrives, only the notification type needs to be sent to the terminal equipment, so that the corresponding tone information can be rendered, thus enabling personalized call notification.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for implementing personalized call notification, comprising:
a switch for calling a callee terminal equipment according to a call request coming from a caller terminal equipment;
an application server for storing therein a profile containing the personalized information of said callee and selecting the type of call notification according to said profile and the information related to said call request that comes from said switch; and
a service server for storing therein tone information corresponding to respective call notification types and based on the selection of said application server, sending the media information corresponding to said selected call notification type to said callee terminal equipment.

2. The system for implementing personalized call notification according to claim 1, wherein said information related to said call request at least includes the callee ID; and said callee's personalized information in said profile includes condition information and the corresponding selection information of a call notification type.

3. The system for implementing personalized call notification according to claim 2, wherein said information related to said call request further includes one or more of the caller ID, callee's location, caller's location and call time; and said switch has a personalized notification triggering database for storing therein the information of the callee IDs for which personalized call notification service has been set; and when the callee ID of said call request is one of the callee IDs in said personalized notification triggering database, said switch sends said information related to said call request to said application server.

4. The system for implementing personalized call notification according to claim 1, wherein said service server sends said tone information to said callee terminal equipment via signaling.

5. A system for implementing personalized call notification, comprising:
a switch for calling a callee terminal equipment according to a call request coming from a caller terminal equipment;
an application server for storing therein a profile containing the personalized information of said callee and selecting the type of call notification according to said profile and the information related to said call request that coms from said switch; and
a service server for storing therein the tone information corresponding to respective call notification types and based on the selection of said application server, sending the tone information corresponding to said selected call notification type to said switch;
wherein said switch sends the corresponding ringing signal to said callee terminal equipment according to said tone information coming from said service server.

6. The system for implementing personalized call notification according to claim 5, wherein said information related to said call request at least includes the callee ID; and said callee's personalized information in said profile includes condition information and the corresponding selection information of a call notification type; and said service server sends said tone information to said switch via signaling.

7. A method for implementing personalized call notification, comprising: sending a call request to a callee from a caller;
selecting a call notification type according to said call request and said callee's personalized information;
sending tone information to a callee terminal equipment; and
rendering said tone information on the callee terminal equipment as a call notification.

8. The method for implementing personalized call notification according to claim 7, wherein said rendering step comprises, ringing on the callee terminal equipment according to said ringing signal as a call notification.

9. The method for implementing personalized call notification according to claim 8, further comprising:
selecting a call notification type according to said call request and said callee's personalized information;
sending the selected call notification type to a callee terminal equipment;
determining whether the tone information corresponding to said call notification type has been stored on said terminal equipment;
when the result of said determination is negative, sending the tone information corresponding to said call notification type to said terminal equipment; and
rendering said tone information on the callee terminal equipment as a call notification in stead of said ringing signal.

10. The method for implementing personalized call notification according to claim 7, wherein said tone information to be send to said callee's terminal equipment includes information corresponding to the selected call notification type.

11. The method for implementing personalized call notification according to claim 10, wherein said tone information to be send to said callee's terminal equipment includes selected call notification type information, and said terminal equipment has stored therein the tone information corresponding to said call notification type.

12. The method for implementing personalized call notification according to claim 7, wherein said tone information is sent to said callee's terminal equipment via a switch to which said callee terminal equipment is connected; further comprising the step of converting said tone information into the corresponding ringing signal at said switch and sending it to said callee terminal equipment.

13. The method for implementing personalized call notification according to claim 12, wherein said step of sending the selected call notification type to the callee terminal equipment sends the call notification type via signaling.

14. The method for implementing personalized call notification according to claim 7, wherein said callee's personalized information includes condition information and the corresponding selection information of a call notification type; and said step of sending the tone information to the switch to which the callee terminal equipment is connected sends the tone information via signaling.

15. A telephone terminal equipment, comprising:
a notification tone receiving unit for receiving tone information of a personalized call notification when a incoming call arrives; and
a notification tone rendering unit.

16. The telephone terminal equipment according to claim 15, wherein said notification tone rendering unit is used for rendering the received tone information of a personalized call notification to notify the user that a call arrives, further comprising:
a notification type receiving unit for receiving the type information of a personalized call notification, wherein each type of personalized call notification corresponds to a piece of tone information; and
a notification tone storage unit for storing the tone information of a received personalized call notification;
wherein when said notification tone storage unit has stored therein the tone information to be rendered, said tone information is not received again.

17. The telephone terminal equipment of claim 16, wherein said notification tone rendering unit renders the tone information corresponding to said call notification type according to the type information of the call notification received by the notification type receiving unit to notify the user there is an incoming call; further comprising:
a notification tone storage unit for storing the tone information of a received personalized call notification;
a notification type receiving unit for receiving the type information of a personalized call notification when an incoming call arrives, wherein each type of personalized call notification corresponds to a piece of tone information.

18. An application server, comprising:
a user profile database for storing a profile containing the personalized information for personalized call notification;
a call information receiving means for receiving information related to a call request; and
a notification type selecting means for selecting a call notification type for a call request according to the received information related to the call request and the personalized information stored in said user profile database.

19. A service server, comprising:
a notification tone database for storing a plurality of call notification types and their corresponding tone data;
a notification tone retrieving means for retrieving the tone data corresponding to a specified notification type from said notification tone database; and
a notification tone outputting means for outputting the tone data retrieved by said notification tone retrieving means.

20. A switch, comprising:
a personalized notification triggering database for storing the users' information for which personalized call notification has been set;
a personalized notification determining means for determining whether the callee of a received call request has set personalized call notification according to the information in said personalized notification triggering database; and
a call information outputting means for outputting the information related to the call request for which the callee has set personalized call notification according to the determination result of said personalized notification determining means.
